(19) United States
(12) Patent Application Publication
(10) Pub. No.: US 2022/0413858 A1
(43) Pub. Date: Dec. 29, 2022

(54) PROCESSING DEVICE AND METHOD OF USING A REGISTER CACHE

(71) Applicant: Advanced Micro Devices, Inc., Santa Clara, CA (US)

(72) Inventor: Maxim V. Kazakov, San Diego, CA (US)

(73) Assignee: Advanced Micro Devices, Inc., Santa Clara, CA (US)

(21) Appl. No.: 17/361,118

(22) Filed: Jun. 28, 2021

(51) Int. Cl. G06F 9/30; G06F 12/0891

(52) U.S. Cl. CPC G06F 9/30138; G06F 9/30109; G06F 12/0891

(57) ABSTRACT

A processing device is provided which comprises memory, a plurality of registers and a processor. the processor is configured to execute a plurality of portions of a program, allocate a number of the registers per portion of the program such that a number of remaining registers are available as a register cache and transfer data between the number of registers, which are allocated per portion of the program, and the register cache. The processor loads data to the allocated registers to execute a portion of the program, stores data, resulting from execution of the portion, in the register cache, reloads the data in the allocated registers and executes another portion of the program using the data reloaded to the allocated registers and A called function uses the number of allocated registers, which is less than an architectural limit of registers allocated per portion of the program.

### BACKGROUND

Processors (e.g., CPU and GPU) have a fixed number of registers which are used to store data to be executed according to a set of instructions of a program. When a program is compiled, the compiler maps the instructions to the registers for execution. During compilation of a program, the registers can reach their capacity (e.g., due to excessive amount of state used for the program) and data, corresponding to a portion of a program stored in the registers for execution, is instead stored in memory. Accordingly, the processor transfers data back and forth between memory and the registers to execute the program.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram illustrating example components for implementing one or more features of the disclosure;

FIG. 3 is a block diagram illustrating example components of a compute unit shown in FIG. 2 for implementing one or more features of the disclosure;

FIG. 4 is a flow diagram illustrating an example method of executing a program using a register cache according to features of the present disclosure; and

FIG. 5 is a flow diagram illustrating another example method of executing a program using a register cache according to features of the present disclosure.

### DETAILED DESCRIPTION

The bandwidth afforded by registers (i.e., amount of data that can be transferred to and from the registers over a period of time) is much higher than the bandwidth afforded by memory (i.e., amount of data that can be transferred to and from the memory over the same period of time). Accordingly, the greater the number of registers present in a device, the more data can be loaded to the registers and the amount of data movement between memory and the registers is decreased, which positively impacts the overall performance of a device.

CPUs have a relatively smaller number of registers, but typically have less threads (i.e., work items) to be executed within a same time period. Accordingly, the amount of data movement between memory and the registers is relatively small compared to the amount of data movement in accelerated processors, such as a GPU. A GPU typically executes a much larger number of threads of a program in parallel than a CPU. When multiple portions of the register states (i.e., portions of data in the registers) of threads are pushed to memory, the execution of these threads is typically stalled because the memory bandwidth is much less than the register bandwidth, negatively impacting the overall performance.

For the reasons described above, the compiler maps the instructions to the registers in a GPU such that as much data as possible is provided to the registers. But in conventional GPUs, the register files are not only partitioned across lanes, but are also partitioned across groups of threads (e.g., across wavefronts). Multiple wavefronts can be processed in a single compute unit (CU) that shares a space in the register file and the register files are partitioned across the wavefronts being processed by the single CU.

Typically, wavefronts have a fixed register file footprint (i.e. number of registers used to execute a wavefront). Moreover, wavefronts running the same program typically have the same register file footprint. Multiple wavefronts are typically processed in parallel in a CU to decrease the overall latency. For example, when one wavefront is waiting for data from memory, another wavefront executing on the CU, which has an allocated register file portion, is scheduled for processing (e.g., scheduled to perform calculations in arithmetic logic units (ALUs). That is, when one or more wavefronts are idle while waiting for data, one or more other wavefronts can be scheduled and processed using the registers during the time period while the one or more wavefronts are waiting for a memory access instruction to complete (e.g., waiting for data to be pushed from registers to memory or waiting for data to be loaded from memory to the registers), which increases the overall performance.

Because there is a fixed number of registers available and a fixed number of wavefronts to be executed, a determination is made, at compiling, whether to create a smaller register file footprint per wavefront (i.e., reduce the number of registers which can be used by a wavefront) or whether to create a larger register file footprint per wavefront. Increasing the register file footprint per wavefront allows more wavefronts to use the fixed number of registers to cover the idleness latency described above, but because each wave has a smaller register file footprint, the number of memory accesses by the wavefronts increases. Likewise, decreasing the register file footprint per wavefront reduces the number of memory accesses by the wavefronts, but less wavefronts are able to use the fixed number of registers which decreases the chances of one wavefront covering the idleness latency incurred by another wavefront.

The present disclosure provides devices and methods which accelerate execution of wavefronts that have a fixed register file footprint by allocating, at compiling, a number of the registers per portion of a program (e.g., a group of threads, such as a wavefront) such that a number of remaining registers are available as a register cache during execution. For example, if a device has 256 registers and 8 wavefronts can be executed in parallel, instead of allocating 32 registers (i.e., 256/8=32) per wavefront (e.g., the number of registers provided per wavefront as an architectural limit), each wavefront is allocated a reduced footprint (i.e., less than the architectural limit) of 16 registers and the remaining registers become available as the register cache. That is, the 8 wavefronts consume 128 registers and the remaining 128 registers become available as the register cache.

In addition, the register cache is used as initial cache storage for operations (e.g., spill operations) which are performed as a result of the reduced register file footprint. That is, although additional memory accesses are generated to execute the wavefronts because a smaller number of registers (i.e., smaller wavefront register footprint) are available for the wavefronts to execute, implementation of the register cache as additional data storage increases the overall efficiency and performance of the program because these memory accesses can be performed via register to register (i.e., larger bandwidth) transfers instead of register to memory (i.e., smaller bandwidth).

For example, in conventional GPUs, space in the registers is freed up to execute a wavefront by writing (i.e., spilling), via the slower memory bandwidth, the data from the registers to memory (e.g., cache memory or main memory), which is known as a spill operation. The data is later reloaded back to the registers from memory and the data is used to execute wavefronts. Because features of the present disclosure allocate a portion of the registers as the register cache, however, the data can be spilled from the registers allocated to the wavefront register footprints to the register cache. The data in the register cache can also be transferred back from the register cache to the registers allocated to the wavefront register footprint. That is, instead of the data being transferred between registers and memory which has a smaller bandwidth, the data is transferred from register to register which has a larger bandwidth. When the register cache is filled, data is then sent to memory. But use of the register cache facilitates less memory to memory transfers by using the additional register to register transfers, resulting in a more efficient overall performance.

In addition, issues arise when a program, which allocates a number of registers at compiling, later calls a function (e.g., library function) which is separately compiled and the compiler uses a larger amount registers for execution of the function to avoid generating a large amount of slower memory accesses (i.e., due to lower memory bandwidth). In a CPU, each portion of the code (including library functions) is compiled for a fixed register footprint defined by the CPU architecture that does not change during execution of a thread. In contrast to a GPU, the threads in a CPU do not partition common register files during their execution. The registers can be freed up via a spill operation and used for the called functions for timely execution. When the data for the function is returned, the previous register state can be restored via a reload operation. Because the amount of concurrently executing threads and the amount of registers per thread are relatively small, the spill and reload operations executed in a CPU are more performant than those executed in a GPU.

In the presence of separate compilation of library functions, the compiler can pick different register footprint for different functions due to the ability for the concurrently executing wavefronts on a GPU while partitioning the common register file. The register footprint in a GPU, however, cannot be dynamically changed to account for the footprint difference between caller code and callee function. For example, if 128 registers are created as the register file footprint per wavefront for a program and the program calls a library function which requests 256 registers to complete its execution within a latency time period tolerance, the footprint cannot be dynamically changed to account for the additional registers.

Some conventional techniques include dynamically adjusting the number of registers per wavefront. These techniques, include complicated algorithms however, which can result in additional issues that negatively impact the overall performance.

According to features of the present disclosure, a negative performance impact of additional spills and reloads generated by the compiler for a function compiled for a smaller uniform (i.e. identical for all separately compiled functions) register footprint can be mitigated by the register cache. In addition, when execution of the function is completed, data that was spilled into the register cache and not evicted from the register cache can be transferred back to the registers to be used for execution of the wavefront which initiated the spill. Accordingly, the spilled data is accessed from the register cache instead of being accessed from memory, resulting in shorter access latency periods. The register cache is dynamically shared among the wavefronts for storing the spilled data without any complicated algorithms for dynamically adjusting the number of registers per wavefront.

A processing device is provided which comprises memory, a plurality of registers and a processor. the processor is configured to execute a plurality of portions of a program, allocate a number of the registers per portion of the program such that a number of remaining registers are available as a register cache and transfer data between the number of registers, which are allocated per portion of the program, and the register cache.

A method of executing a program is provided which comprises allocating a number of a plurality of registers per portion of the program such that a remaining number of the registers are available as a register cache, scheduling a first portion of the program for execution, copying data from one or more of the registers allocated per portion of the program to one or more registers of the register cache when a register footprint is not available in the registers allocated per portion of the program, and executing the first

A method of executing a program is provided which comprises allocating a number of a plurality of registers per portion of the program such that a remaining number of the registers are available as a register cache, executing the program, calling a portion of another program which uses a number of registers greater than the number registers allocated per portion of the program, executing the portion of the other program using the registers allocated per portion of the program and transferring data between the registers allocated per portion of the program and the register cache to complete execution of the portion of the other program.

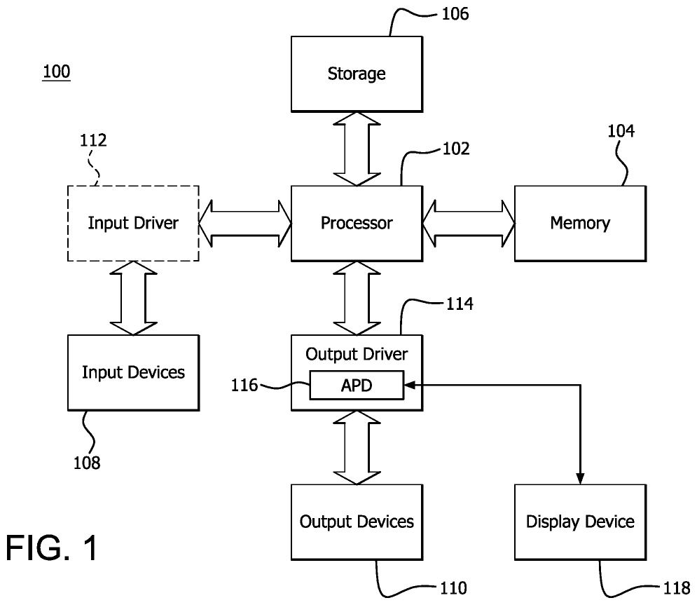

FIG. 1 is a block diagram of an example device 100 in which one or more features of the disclosure can be implemented. The device 100 can include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is be located on the same die as the processor 102, or is located separately from the processor 102. The memory 104 includes a volatile or non-volatile memory, for example, random access memory (RAM), dynamic RAM (DRAM), or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes an accelerated processing device (“APD”) 116 which is coupled to a display device 118.

The APD is configured to accept compute commands and graphics rendering commands from processor 102, to process those compute and graphics rendering commands, and to provide pixel output to display device 118 for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and configured to provide graphical output to a display device 118. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm performs the functionality described herein.

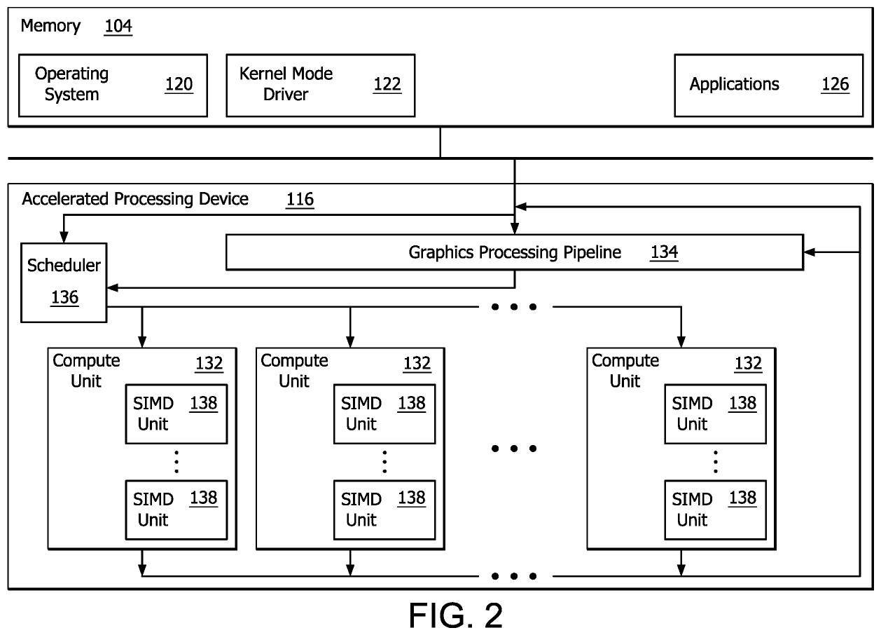

FIG. 2 is a block diagram of the device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the SIMD units 138 discussed in further detail below) of the APD 116.

The APD 116 executes commands and programs for selected functions, such as graphics operations, as well as non-graphics operations that may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

As described in more detail below, the APD 116 is configured to allocate a number of registers per portion of the program such that a number of remaining registers are available as a register cache and transfer data between the number of registers, which are allocated per portion of the program, and the register cache.

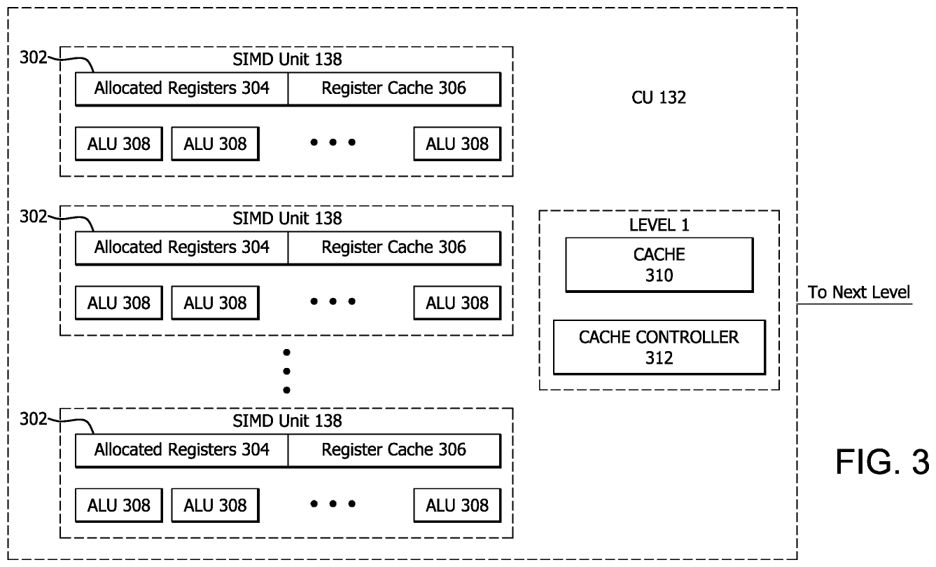

FIG. 3 is a block diagram illustrating example components of a CU 132 shown in FIG. 2 for implementing one or more features of the disclosure.

The CU 132 shown in FIG. 3 is part of an accelerated processing device (e.g., a GPU), such as the APD 116 shown in FIG. 2.

As shown in FIG. 3, each SIMD unit 138 of the compute unit 132 includes a register file 302 and ALUs 308. The CU 132 includes a level 1 cache controller 312 in communication with a corresponding level 1 cache 310. Cache controller 312 can also be in communication with a next cache level (e.g., level 2 cache not shown).

Data is loaded to registers of the register files 302 and used, for example, by the ALUs 308 to execute portions of a program, such as wavefront of a program. The CU 132 receives instructions and executes a fixed number of wavefronts in parallel by loading the data into the registers of the register files 302.

As shown in FIG. 3, a number of the registers of the register file 302 is allocated per portion of the program (i.e., allocated registers 304) and a number of remaining registers in the register file are available as a register cache 306. The CU 132 is configured to transfer data between the allocated registers 304 and the register cache 306 during execution of the portions (e.g., wavefronts) of the program.

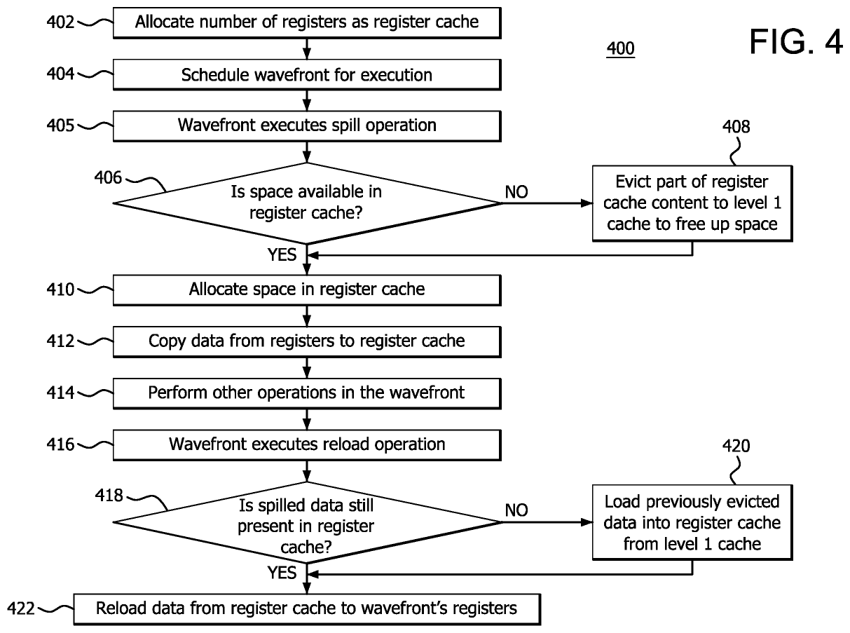

FIG. 4 is a flow diagram illustrating an example method 400 of executing a program using a register cache according to features of the present disclosure. The example shown in FIG. 4 describes portions of a program as wavefronts. Features of the present disclosure can be implement, however, by executing other types of portions of a program. FIG. 4 illustrates an example of using a register cache when performing a spill operation described above.

As shown at block 402, the method 400 includes allocating a number of registers per wavefront, of the registers in the register file (e.g., 302 in FIG. 3) such that a remaining number of the registers are available as a register cache. That is, a number of registers per wavefront is decided at compiling, to execute the program. To start executing a wavefront, a number of the registers of the register file 302 (shown in FIG. 3) of a CU (e.g., CU 132 also shown in FIG. 3) is allocated per wavefront (i.e., allocated registers 304 also shown in FIG. 3) with total number of wavefronts on CU occupying up to capacity of allocated registers 304 and a number of remaining registers in the register file are available as a register cache 306 (also shown in FIG. 3).

As shown at block 404, the method 400 includes scheduling a first wavefront for execution. As shown at decision block 406, a determination is made as to whether or not space (e.g., register footprint) is available in the allocated registers (e.g., allocated registers 304) to timely (e.g., to avoid generating a large amount of slower memory accesses or to execute within latency tolerance threshold) execute the first wavefront.

As shown at block 405, the method 400 includes executing a wavefront spill operation. That is, while executing the wavefront, data is removed from the allocated registers and copied (spilled) to the register cache. After performing the spill operation, a determination is made, at decision block 406, as to whether space is available in the register cache. When it is determined that space is not available in the register cache (NO decision), a portion of the register cache is evicted to the L1 cache to free up space in the register cache, at block 408, and the space is allocated in the register cache, at block 410, by marking (tagging) the entries in the register cache as being used by a wavefront so that another wavefront will not use the marked entry. When it is determined that space is available in the register cache (YES decision), the space is allocated in the register cache, at block 410, by marking (tagging) the entries in the register cache as being used by a wavefront.

After the space is allocated in the register cache, data is copied from the allocated registers to the register cache, at block 412.

When a register footprint is determined, at block 406, to be available (YES decision) in the allocated registers, the first wavefront is executed in the allocated registers at block 408. When a register footprint is determined, at block 406, to not be available in the allocated registers (NO decision), data is copied (e.g., spilled) from the allocated registers to one or more registers of the register cache at block 410. After space in the allocated registers is freed up, the first wavefront is executed using the allocated registers per portion of the program at block 412.

As shown at block 414, other wavefront operations are performed. The wavefront then executes a reload operation at block 416. That is, the wavefront begins executing a reload operation to reload the data that was previously copied (i.e., previously spilled) to the register cache at block 412 to complete execution of the other wavefront operations.

At decision block 418, a determination is made as to whether the previously spilled data is still in the register cache. When it is determined that the previously spilled data has been evicted from the register cache to the L1 cache, the data is loaded from the L1 cache to the register cache, at block 420, and then reloaded to the registers allocated to the wavefront from the register cache at block 422. The register cache is dynamically shared among the wavefronts for storing the spilled data without any complicated algorithms for dynamically adjusting the number of registers per wavefront.

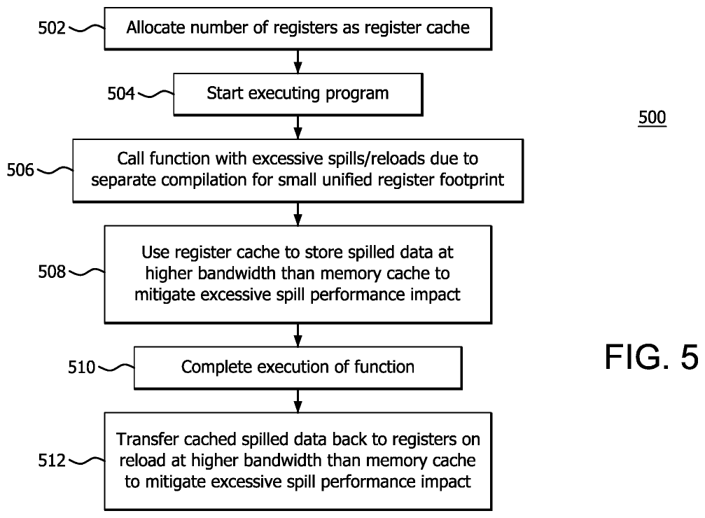

FIG. 5 is a flow diagram illustrating another example method of executing a program using a register cache according to features of the present disclosure. FIG. 5 illustrates an example of using a register cache when executing a called portion of another program (e.g., a library function) which uses a larger number registers for execution than the allocated number of registers as described above. For example, if 128 registers are created as the register file footprint per wavefront for a program and the program calls a library function which requests 256 registers to complete its execution within a latency time period tolerance, the footprint cannot be dynamically changed to account for the additional registers.

As shown at block 502, the method 500 includes allocating a number of a plurality of registers per wavefront such that a remaining number of the registers are available as a register cache. For example, a number of the registers of the register file 302 (shown in FIG. 3) of a CU (e.g., CU 132 also shown in FIG. 3) is allocated per wavefront (i.e., allocated registers 304 also shown in FIG. 3) and a number of remaining registers in the register file are available as a register cache 306 (also shown in FIG. 3).

As shown at block 504, the program begins executing. That is, execution of the program includes executing fixed numbers of wavefronts in parallel at each CU. At block 506, a portion of another program which results in a larger number spills and reloads due to separate compilation for the small register footprint, is called by the executing program. For example, a library function is called by the program.

As shown at block 508, the method 500 includes using the register cache to store the spilled data at a higher bandwidth than the register to L1 cache bandwidth, which mitigates the impact (e.g., latency) by the additional spill operations. That is, when the function is called, register to register transfers can be used in place of register to memory transfers to store the excess spill data, improving the overall performance.

As shown at block 510, execution of the function is completed. The data that was spilled to the register cache is transferred back (i.e., reloaded) to the allocated registers. That is, when execution of the function is completed, data resulting from the execution of the function or data that was spilled into the register cache and not evicted from the register cache can be transferred back to the registers to be used for execution of subsequent wavefronts. Accordingly, the data is accessed from the register cache instead of being accessed from memory, resulting in shorter access latency periods. The register cache is dynamically shared among the wavefronts for storing the spilled data without any complicated algorithms for dynamically adjusting the number of registers per wavefront. The data resulting from the execution of the function or spilled data can also be evicted from the register cache to make room for new data being transferred to the register cache.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, allocated registers 304 and register cache 306 of a register file 302 and ALUs 308 may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A processing device comprising:
memory;
a plurality of registers; and
a processor configured to:
execute a plurality of portions of a program;
allocate a number of the registers per portion of the program such that a number of remaining registers are available as a register cache; and
transfer data between the number of registers, which are allocated per portion of the program, and the register cache.

2. The processing device of claim 1, wherein the plurality of portions of a program are wavefronts.

3. The processing device of claim 1, wherein the processor is configured to:
load data to the registers allocated per portion of the program to execute one of the portions of the program;
store data, resulting from execution of the one portion, in the register cache;
reload the data in the registers allocated per portion of the program; and
execute another portion of the program using the data reloaded to the registers which are allocated per portion of the program.

4. The processing device of claim 3, wherein the data, resulting from execution of the one portion, is stored in a portion of the register cache and is not directly accessible, by other threads of the portion of the program.

5. The processing device of claim 4, wherein the data stored in the portion of the register cache is indirectly accessible, via the memory, by the other threads of the portion of the program.

6. The processing device of claim 1, wherein the processor is configured to execute the plurality of portions of the program without dynamically adjusting the number of registers per portion of the program.

7. The processing device of claim 1, wherein the processor comprises a plurality of compute units each configured to execute a same number of portions of the program, and
the plurality of registers are used by one of the compute units.

8. The processing device of claim 1, wherein the processor executes a register spill operation by copying the data into the register cache.

9. The processing device of claim 1, wherein a called function uses the number of registers, allocated per portion of the program, which is less than an architectural limit of registers allocated per portion of the program.

10. A method of executing a program comprising;
allocating a number of a plurality of registers per portion of the program such that a remaining number of the registers are available as a register cache;
scheduling a first portion of the program for execution;
copying data from one or more of the registers allocated per portion of the program to one or more registers of the register cache when a register footprint is not available in the registers allocated per portion of the program; and
executing the first portion of the program using the registers allocated per portion of the program.

11. The method of claim 10, further comprising:
determining whether or not a register footprint is available in the registers allocated per portion of the program; and
executing the first portion of the program using the registers allocated per portion of the program without copying the data to the register cache when a register footprint is determined to be available in the registers allocated per portion of the program.

12. The method of claim 10, further comprising:
scheduling a second portion of the program for execution;
reloading the data, copied to the register cache, to the registers allocated per portion of the program to execute the second portion of the program; and
executing the second portion of the program using the registers allocated per portion of the program.

13. The method of claim 12, wherein the first portion of the program and the second portion of the program are wavefronts.

14. The method of claim 12, further comprising executing the first portion of the program and the second portion of the program without dynamically adjusting the number of registers per portion of the program.

15. The method of claim 10, wherein the data resulting from execution of the first portion of the program is stored in a portion of the register cache,
the data stored in the portion of the register cache is not directly accessible by other threads of the portion of the program, and
the data stored in the portion of the register cache is indirectly accessible, via the memory, by the other threads of the portion of the program.

16. A method of executing a program comprising;
allocating a number of a plurality of registers per portion of the program such that a remaining number of the registers are available as a register cache;
executing the program;
calling a portion of another program which uses a number of registers greater than the number registers allocated per portion of the program;
executing the portion of the other program using the registers allocated per portion of the program; and
transferring data between the registers allocated per portion of the program and the register cache to complete execution of the portion of the other program.

17. The method of claim 16, wherein the portion of the other program is a library function.

18. The method of claim 16, further comprising:
after completing execution of the portion of the other program, transferring other data from the registers allocated per portion of the program to the register cache; and
evicting data, resulting from execution of the portion of the other program, from the register cache to memory.

19. The method of claim 16, further comprising:
after completing execution of the portion of the other program, reloading the data, resulting from execution of the portion of the other program, from the register cache to the registers allocated per portion of the program.

20. The method of claim 16, further comprising executing the portion of the program and the portion of the other program without dynamically adjusting the number of registers per portion of the program.
